(19) United States
(12) Patent Application Publication
(10) Pub. No.: US 2026/0336371 A1
(43) Pub. Date: Oct. 29, 2026

(54) CARGO BED COVER AND VEHICLE INCLUDING CARGO BED COVER

(71) Applicants: Hyundai Motor Company, Seoul (KR); Kia Corporation, Seoul (KR)

(72) Inventors: Jae Seung LEE, Hwaseong-Si (KR); Min Su KIM, Seoul (KR); Woo Sik YOON, Incheon (KR)

(21) Appl. No.: 19/348,977

(22) Filed: Oct. 3, 2025

(30) Foreign Application Priority Data
Apr. 23, 2025 (KR) 10-2025-0053255

(51) Int. Cl. B60J 7/057; E04H 15/06

(52) U.S. Cl. CPC B60J 7/057; E04H 15/06

(57) ABSTRACT

A cargo bed cover includes guide rails each rotatably provided on each side, in a width direction, of a cargo bed of a vehicle; driving units configured to rotate the guide rails, a cover panel slidably moving along the guide rails, the cover panel provided to be foldable, and a tent frame detachably coupled to the guide rail, the tent frame having a tent cover on the inside thereof.

### CROSS-REFERENCE TO RELATED APPLICATION(S)

This application claims benefit of priority to Korean Patent Application No. 10-2025-0053255 filed on Apr. 23, 2025 in the Korean Intellectual Property Office, the disclosure of which is incorporated herein by reference in its entirety.

### TECHNICAL FIELD

The present disclosure relates to a cargo bed cover and a vehicle including the same.

### BACKGROUND

A cargo space of a vehicle may be provided in an open form for loading and/or transporting cargo, but a cover may be used to protect the cargo from external environmental factors. In vehicles such as pickup trucks, a cargo bed (e.g., truck bed) may be exposed externally, and thus various cover structures for protecting the cargo bed have been developed.

Among vehicle cargo bed covers, a tonneau cover has been widely used. The tonneau cover serves to cover a cargo space and protect contents in the cargo space. The tonneau is designed to have a lightweight structure, thereby minimizing degradation in fuel efficiency of a vehicle. The tonneau cover has a panel-shaped structure covering an end of a cargo bed of the vehicle.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses/devices, and methods are described for a cargo bed cover and vehicle comprising a cargo bed cover. A cargo bed cover may comprise: guide rails rotatably provided on opposite sides, in a first direction, of a cargo bed of a vehicle; one or more actuators configured to rotate the guide rails; a cover panel configured to slidably move along the guide rails, wherein the cover panel is foldable; and a tent frame, detachably coupled to the guide rails, configured to reversibly enclose a tent cover.

Also, or alternatively, a cargo bed cover may comprise: guide rails provided on opposite sides, in a first direction, of a cargo bed of a vehicle, wherein first sides of the guide rails comprise first ends, in a second direction perpendicular to the first direction, rotatably hinged to a first side, in the second direction, of the cargo bed; one or more actuators configured to rotate the guide rails about the first ends of the guide rails; and a cover panel configured to move along the guide rails.

A vehicle may comprise a cargo bed and a cargo bed cover. The cargo bed may comprise, for example: guide rails rotatably provided on opposite sides, in a first direction, of a cargo bed of a vehicle; one or more actuators configured to rotate the guide rails; a cover panel configured to slidably move along the guide rails, wherein the cover panel is foldable; and a tent frame, detachably coupled to the guide rails, configured to reversibly enclose a tent cover. Also, or alternatively, the cargo bed may comprise: guide rails provided on opposite sides, in a first direction, of a cargo bed of a vehicle, wherein first sides of the guide rails comprise first ends, in a second direction perpendicular to the first direction, rotatably hinged to a first side, in the second direction, of the cargo bed; one or more actuators configured to rotate the guide rails about the first ends of the guide rails; and a cover panel configured to move along the guide rails.

These and other features and advantages are described in greater detail below.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view of a state in which a cover panel of a cargo bed cover is closed according to an example;

FIG. 2 is a perspective view of a state in which a cover panel of a cargo bed cover is open according to an example;

FIG. 3 is a bottom perspective view of a cargo bed cover according to an example;

FIG. 4 is a side view of a cargo bed cover according to an example;

FIG. 5 is an exploded perspective view of a cargo bed cover according to an example;

FIG. 6 is a perspective view of a tent roller frame according to an example;

FIG. 7 is a cross-sectional view taken along line A-A′ of FIG. 6;

FIG. 8 is an enlarged view of portion “B” of FIG. 1;

FIG. 9 is a partially exploded view of a cargo bed cover according to an example;

FIG. 10 is a perspective view of a state in which a cover panel is folded in the cargo bed cover according to an example;

FIG. 11 is a cross-sectional view taken along line C-C′ of FIG. 8;

FIG. 12 is a side view of a driving unit of a cargo bed cover according to an example;

FIG. 13 is a side view of a state in which a cargo bed cover is raised by a driving unit according to an example;

FIG. 14 is a perspective view of a state in which a cargo bed cover is provided in a first mode on a vehicle according to an example;

FIG. 15 is a cross-sectional view of a state in which a cargo bed cover is provided in a first mode on a vehicle according to an example;

FIG. 16 is a perspective view of a state in which a cargo bed cover is provided in a second mode on a vehicle according to an example;

FIG. 17 is a cross-sectional view of a state in which a cargo bed cover is provided in a second mode on a vehicle according to an example;

FIG. 18 is a perspective view of a state in which a cargo bed cover is provided in a third mode on a vehicle according to an example;

FIG. 19 is a perspective view of a state in which a cover panel is open in FIG. 18; and

FIG. 20 is a cross-sectional view of a state in which a cargo bed cover is provided in a third mode on a vehicle according to an example.

### DETAILED DESCRIPTION

Various modifications may be made to the examples. Here, the examples are not construed as limited to the disclosure and should be understood to include all changes, equivalents, and replacements within the idea and the technical scope of the disclosure.

The terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component. The term “and/or” may include combinations of a plurality of related described items or any of a plurality of related described items.

The terms such as “unit,” “portion,” “part,” and the like may be used to describe various components, but the components should not be limited by the terms. The above-described terms may refer to a term indicating not only a physically/visually distinct component, but also a function or component of a corresponding portion even when not clearly divided or partitioned.

The terminology used herein is for the purpose of describing particular examples only and is not to be limiting of the examples. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this disclosure, specify the presence of stated features, integers, operations, operations, elements, components or a combination thereof, but do not preclude the presence or addition of one or more other features, integers, operations, operations, elements, components, and/or groups thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

Unless otherwise defined herein, all terms used herein, including technical or scientific terms, have the same meanings as those generally understood by one of ordinary skill in the art. Terms defined in dictionaries generally used should be construed to have meanings matching contextual meanings in the related art and are not to be construed as having an ideal or excessively formal meaning, unless otherwise defined herein.

In the description below, the terms “front,” “rear,” “upper,” “lower,” “top,” “bottom,” and the like used in relation to directions are defined based on the drawings, and are not intended to indicate an absolute direction/orientation in space.

Hereinafter, examples of the present disclosure will be described in more detail with reference to the accompanying drawings.

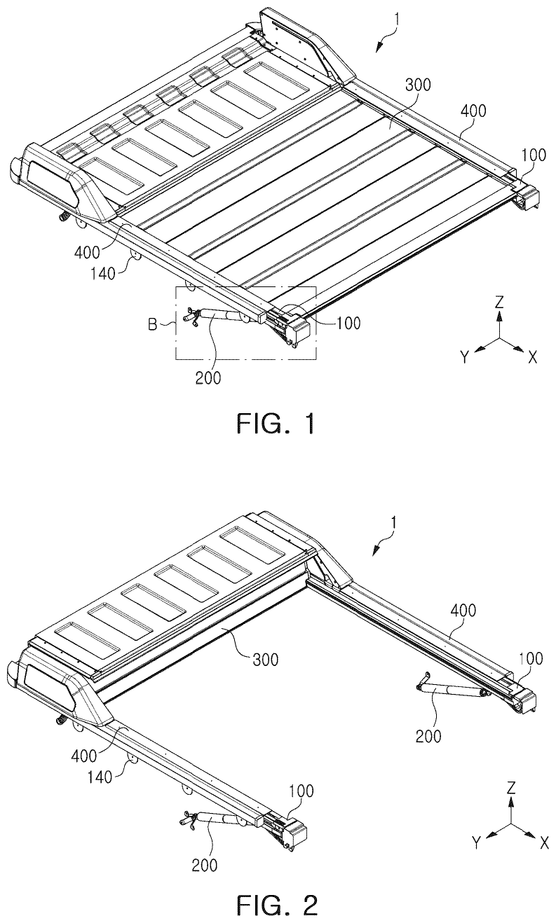

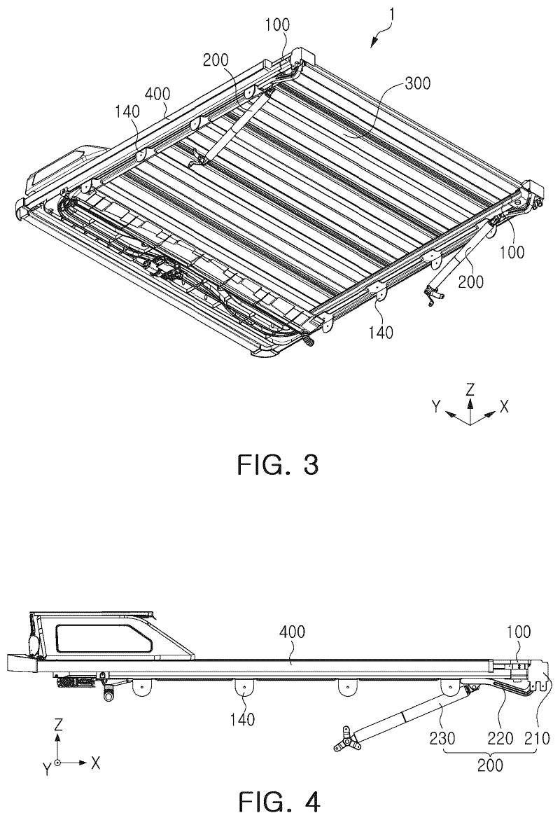

FIG. 1 is a perspective view of a state in which a cover panel of a cargo bed cover is closed according to an example. FIG. 2 is a perspective view of a state in which a cover panel of a cargo bed cover is open according to an example. FIG. 3 is a bottom perspective view of a cargo bed cover according to an example. FIG. 4 is a side view of a cargo bed cover according to an example.

Referring to FIGS. 1 to 4, a cargo bed cover 1 according to an example may include a guide rail 100, a driving unit 200 (e.g., one or more actuators, one or more motors, etc.), a cover panel 300, and a tent frame 400.

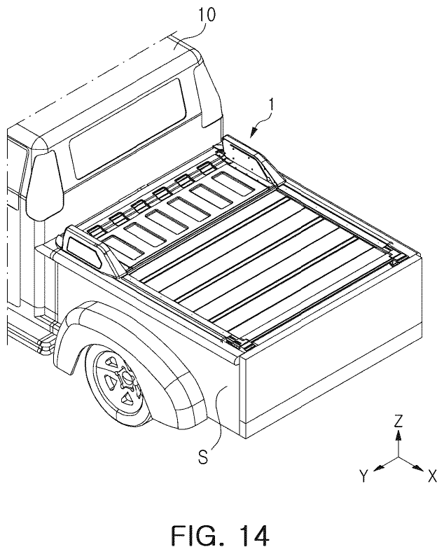

The guide rail 100 may be provided on a side, in a width direction (e.g., in a first direction, a width direction of a vehicle comprising the cargo bed S, etc.), of a cargo bed S (see FIG. 14 for example cargo bed S) of a vehicle 10. Guide rails 100 may be provided on both sides of the vehicle 10 in the width direction (e.g., a first guide rail 100 may be provided on a left side, and a second guide rail may be provided on the right side). Guide rails 100 may be configured symmetrically in the width direction. As such, a guide rail 100 and corresponding parts/relationships with corresponding parts will be referred to herein, but one skilled in the art will understand that the description may refer to multiple guide rails (e.g., two guide rails) and corresponding parts/relationships with corresponding parts. For example, the guide rail 100 may be provided in a length direction (e.g., second direction perpendicular to the first/width direction, a longitudinal direction of the guide rail 100) on both internal side surfaces of the cargo bed S (e.g., sides of a surface towards an inside of the cargo bed) in the width direction. The guide rail 100 may be fixed to the cargo bed S via/by a guide rail fixing bracket 140. A first side of the guide rail 100 (e.g., in the length direction of the guide rail 100) may be rotatably attached (e.g., hinged) to a first side of the cargo bed S (e.g., in the length direction). The guide rail 100 may be rotatable about the attachment at the first side in the length direction. When/if the guide rail 100 rotates, a distance between a second side of the guide rail 100 in the length direction (e.g., opposite the first side of the guide rail 100) and a second side of the cargo bed S in the length direction (e.g., opposite the first side of the cargo bed S in the length direction) may change (e.g., increase or decrease depending on a direction of the rotating). Here, the terms for directions are defined as follows: a length direction may refer to an X-axis direction with reference to FIG. 1, a width direction may refer to a Y-axis direction with reference to FIG. 1, and a thickness direction may refer to a Z-axis direction with reference to FIG. 1.

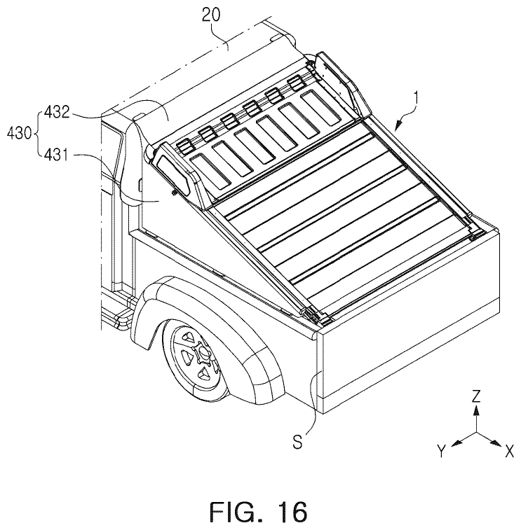

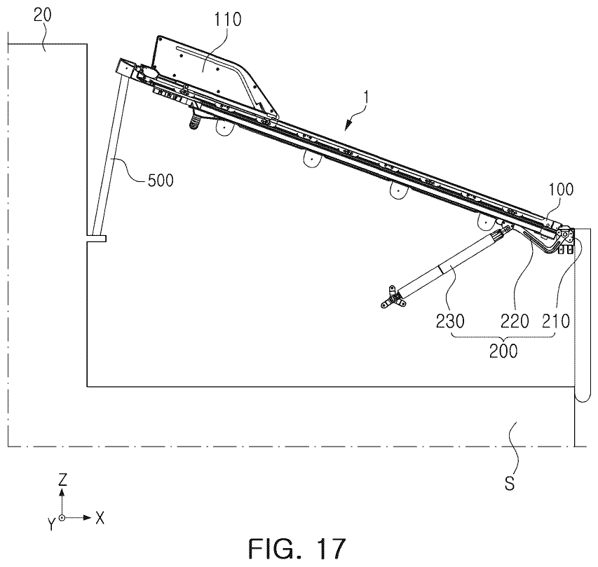

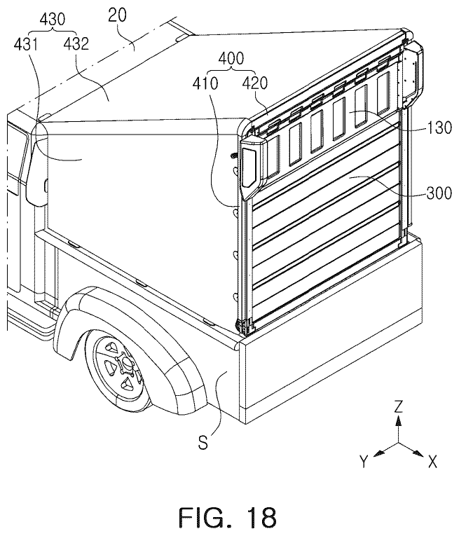

The driving unit 200 may rotate the guide rail 100. As the driving unit 200 (e.g., motor, actuator, etc.) rotates the guide rail 100, a mode of the cargo bed cover 1 according to an example may be switched to/between a first mode (see FIG. 14), a second mode (see FIG. 16), or a third mode (see FIG. 18).

When/if the cargo bed cover 1 is in the first mode, the cargo bed cover 1 may be mounted on an upper end of the cargo bed S in the thickness/height direction. In the first mode, an upper portion of the cargo bed S may be opened or closed by slidably moving the cover panel 300.

The cover panel 300 may be provided to be slidably movable along the guide rail 100. When/if the cover panel 300 slidably moves along the guide rail 100, the cover panel 300 may be folded. From a state in which the cover panel 300 is unfolded on the guide rail 100 (see FIG. 1), the cover panel 300 may be folded in the length direction along the guide rail 100 (see FIG. 2). The cover panel 300 may be provided as a plurality of cover panels 300. For example, a first cover panel 300 may be rotatably hinged to a second cover panel 300 disposed to be adjacent to the first cover panel 300 in the length direction.

The tent frame 400 may be detachably provided on the guide rail 100. The tent frame 400 may include a tent cover 430. The tent cover 430 may be rolled (e.g., elastically) and coupled to an inside of the tent frame 400. For example, the tent cover 430 may be provided on the inside of the tent frame 400 using an elastic member (elastic strap, cord, spring, material, etc.). Accordingly, when/if an external force is applied to the tent cover 430, the tent cover 430 may be drawn out to the outside of the tent frame 400. If/when the external force is released from the tent cover 430, the tent cover 430 may return to an original position thereof. In other words, if/when the external force is released, the tent cover 430 may return to the inside of the tent frame 400.

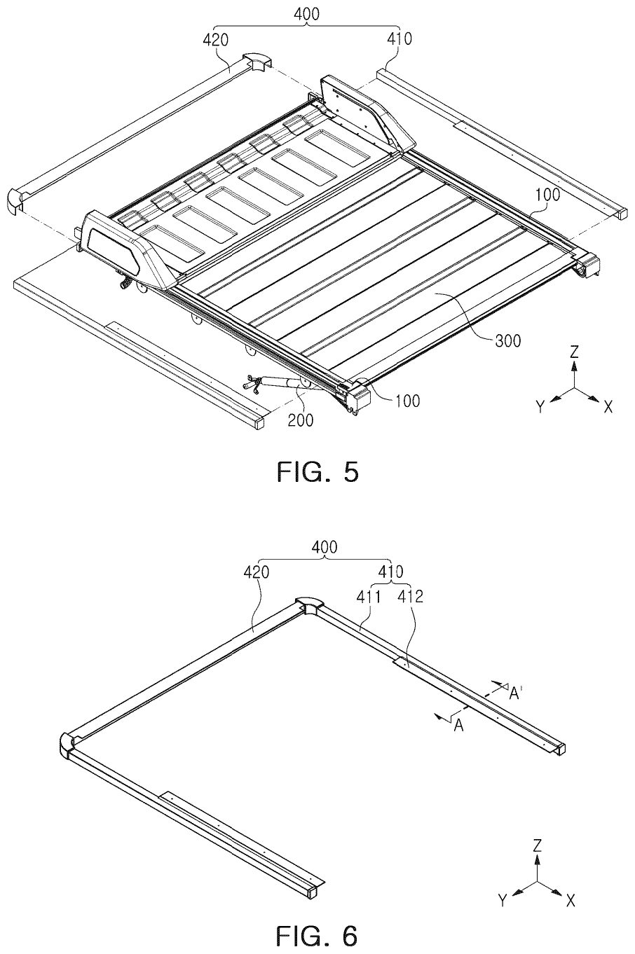

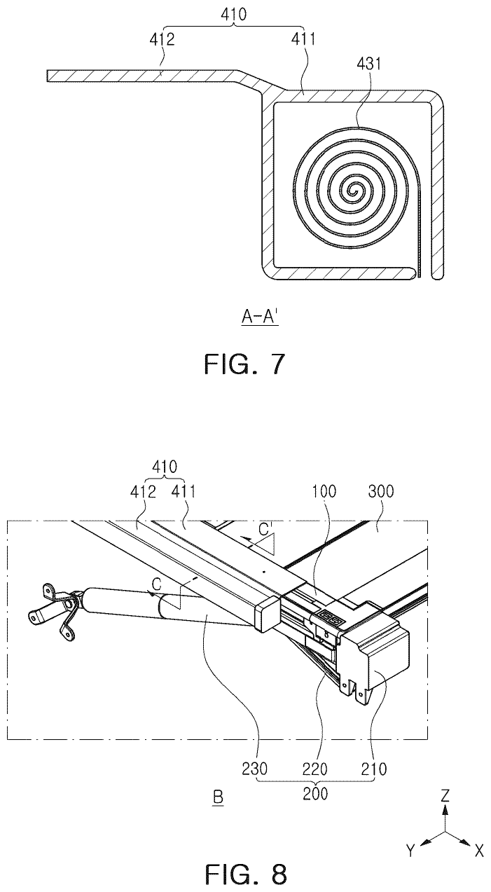

FIG. 5 is an exploded perspective view of a cargo bed cover according to an example. FIG. 6 is a perspective view of a tent roller frame according to an example. FIG. 7 is a cross-sectional view taken along line A-A′ of FIG. 6. FIG. 8 is an enlarged view of portion “B” of FIG. 1.

Referring to FIGS. 5 to 8, the tent frame 400 may be detachably coupled to the guide rail 100. When/if the guide rail 100 is rotated by the driving unit 200, the tent frame 400 may be rotated together with the guide rail 100. The tent frame 400 may have the tent cover 430 attached thereto (see FIG. 18). The tent cover 430 may be provided to be drawn out to the outside of the tent frame 400. For example, the tent cover 430 may be elastically rolled and coupled to the tent frame 400. Here, the term “elastically rolled and coupled” may refer to a coupling state in which the tent cover 430 is rolled in a state in which a first side of the tent cover 430 is fixed to the inside of the tent frame 400 by an elastic member, such as a spring, elastic cord/strap/material, etc. Being elastically rolled and coupled may refer to a coupling method in which the tent cover 430 may be drawn out to the outside of the tent frame 400 when/if a second side of the tent cover 430 is pulled, and the tent cover 430 may be rolled into the inside of the tent frame 400 when/if a force of the pulling the second side of the tent cover 430 is released/reduced. For example, the tent cover 430 may be drawn out to the outside of the tent frame 400 when/if the cargo bed cover 1 is in the second mode or the third mode. An end of the tent cover 430 that is drawn out may be fixed to the cargo bed S. For example, the tent cover 430 may be fixed to the cargo bed S using a fixing means such as a hook, a carabiner, or the like. When/if the end of the tent cover 430 is separated from the cargo bed S, the tent cover 430 may return to the inside of the tent frame 400. The tent cover 430 may include, for example, a side tent cover 431 and/or a front tent cover 432. When/if the side tent cover 431 and the front tent cover 432 are drawn out to the outside of the tent frame 400, adjacent portions of the side tent cover 431 and the front tent cover 432 may be connected to each other. For example, the adjacent portions of the side tent cover 431 and the front tent cover 432 may be connected to each other by a Velcro, a zipper, a hook, or the like.

The tent frame 400 may include, for example, a side frame 410 and a connecting frame 420. The side frame 410 may be provided as a pair of side frames 410 spaced apart from each other in the width direction. In other words, each side frame 410 may be connected to a corresponding each of the guide rails 100 disposed on each side of the cargo bed S in the width direction (e.g., a first side frame 410 may be connected to a first guide rail 100 on a first side, in the width direction, of the cargo bed S, and a second side frame 410 may be connected to a second guide rail 100 disposed on a second side, opposite the first side in the width direction, of the cargo bed S). The side tent cover 431 may be provided on the inside of the side frame 410. The side tent cover 431 may be elastically rolled and coupled to the inside of the side frame 410. Accordingly, when/if an external force is applied to the side tent cover 431, the side tent cover 431 may be drawn out to the outside of the side frame 410. When/if the external force is released, the side tent cover 431 may return to an original position. That is, the side tent cover 431 may return to the inside of the side frame 410.

The side frame 410 may include, for example, a side part 411 (e.g., side chamber) having the side tent cover 431 therein, the side part 411 disposed on the outside of the guide rail 100 in the width direction, and a flange part 412 (e.g., flange) extending from the side part 411. The flange part 412 may be coupled to the guide rail 100. The flange part 412 may be detachably coupled to the guide rail 100 using, for example, a fastening member such as a bolt or the like. However, as long as the flange part 412 is detachably fixed to the guide rail 100, a method of connecting the flange part 412 to the guide rail 100 may be changed in various manners. The side frame 410 may be fixedly coupled to the guide rail 100 (e.g., not detachably, so as not to be separated from the guide rail 100), for example, using a more fixed method such as welding or the like.

The connecting frame 420 may connect the pair of side frames 410 to each other in the width direction. For example, the connecting frame 420 may connect sides/ends of the pair of side frames 410 to each other in the length direction. Accordingly, the tent frame 400 may have an overall C-shape. the front tent cover 432 (see FIG. 18) may be provided on the inside of the connecting frame 420. The front tent cover 432 may be elastically rolled and coupled to the inside of the connecting frame 420. Accordingly, when/if an external force is applied to the front tent cover 432, the front tent cover 432 may be drawn out to the outside of the connecting frame 420. When/if the external force is released from the front tent cover 432, the front tent cover 432 may return to an original position thereof. That is, the front tent cover 432 may return to the inside of the connecting frame 420.

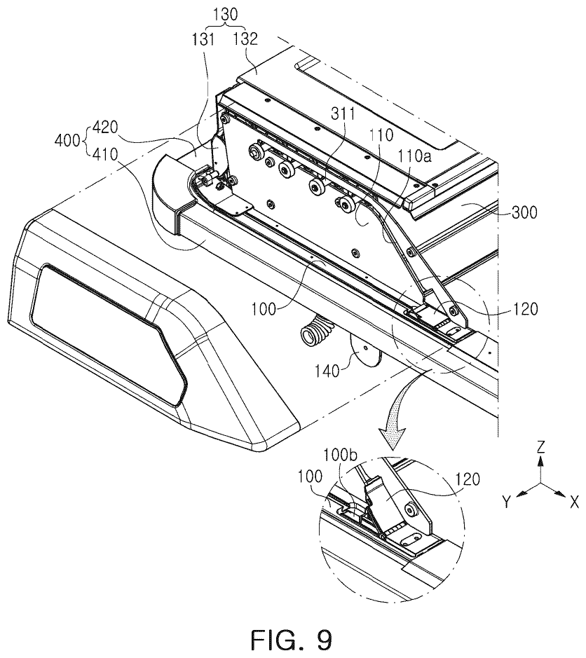

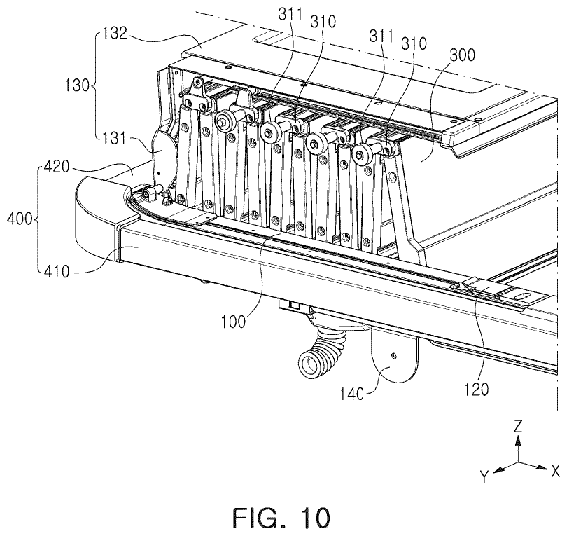

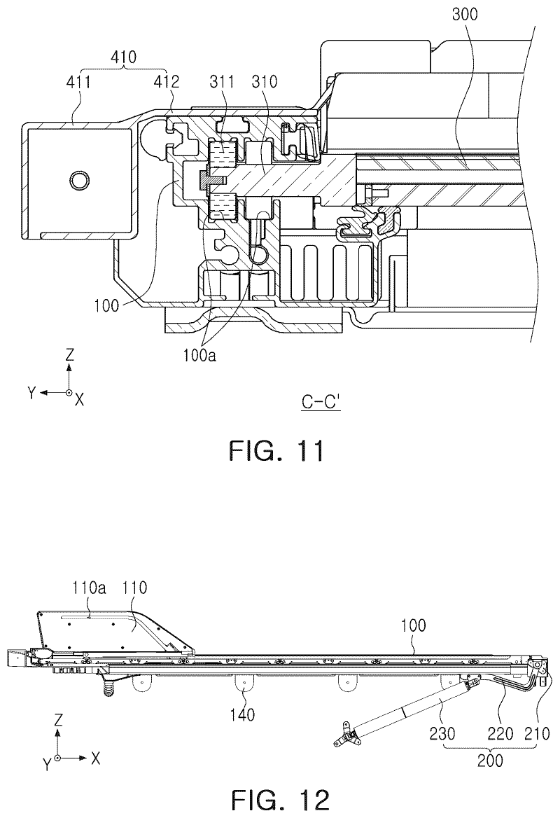

FIG. 9 is a partially exploded view of a cargo bed cover according to an example. FIG. 10 is a perspective view of a state in which a cover panel is folded in the cargo bed cover according to an example. FIG. 11 is a cross-sectional view taken along line C-C′ of FIG. 8.

Referring to FIGS. 9 to 11, the cover panel 300 may be provided to be slidable along the guide rail 100. For example, both ends of the cover panel 300 in the width direction may be mounted on the guide rail 100, and may slidably move in the length direction. Both ends of the cover panel 300 in the width direction may move along a first guide groove 100a of the guide rail 100 (e.g., formed in inside surfaces of the guide rails 100). The cover panel 300 may be provided as a plurality of cover panels 300. The plurality of cover panels 300 may be rotatably hinged to each other in the length direction. For example, ends of the plurality of cover panels 300 in the length direction may be rotatably connected to a connecting bracket 310. The connecting bracket 310 may connect the plurality of cover panels 300 to each other in a foldable manner. The connecting bracket 310 may have a guide roller 311. When/if the cover panel 300 is folded, the guide roller 311 may move along the guide rail 100. A portion of the guide roller 311 may move to an outside of the guide rail 100 during folding of the cover panel 300. The portion of the guide roller 311 may move along a guide panel 110. The guide panel 110 may be provided on the other side of the guide rail 100 in the length direction, and may guide movement of the cover panel 300. For example, a portion of the guide roller 311 may move along the first guide groove 100a provided in the guide rail 100, and may pass through an opening 100b of the guide rail 100 and move along a second guide groove 110a of the guide panel 110 (e.g., the second guide groove 110a being aligned with the first guide groove 100a). The second guide groove 110a may include an upwardly inclined section toward the other side of the guide rail 100 in the length direction.

The guide rail 100 may have a cap member 120 (e.g., a cap) for opening and closing the opening 100b. The cap member 120 may connect or separate the first guide groove 100a and the second guide groove 110a to each other or from each other as the cap member 120 rotates. That is, the first guide groove 100a and the second guide groove 110a may be selectively connected to each other depending on whether the cap member 120 rotates and/or to what extent and to where the cap member 120 is rotated. The cap member 120 may be pressed and opened by the guide roller 311 of the cover panel 300 when/if the guide roller 311 moves from the first guide groove 100a of the guide rail 100 to the second guide groove 110a of the guide panel 110. However, when/if moving the guide roller 311 disposed in the second guide groove 110a to the first guide groove 100a, the cap member 120 may be opened only when/if an external force is applied. In other words, even when/if the guide roller 311 disposed in the second guide groove 110a presses the cap member 120, the cap member 120 may not be opened unless a user or other external force/actor rotates the cap member 120 upwardly. When/if the cap member 120 may be opened, the second guide groove 110a and the first guide groove 100a may be connected to each other.

A cover 130 may be provided on the guide rail 100. The cover 130 may be rotatably provided on the guide rail 100. When/if the cover panel 300 is folded, the cover panel 300 may be disposed below the cover 130. The cover 130 may include, for example, a first part 131 (e.g., a first cover portion) having one end rotatably provided on the other side of the guide rail 100 in the length direction, and a second part 132 (e.g., a second cover portion) having both sides in the width direction rotatably connected to the cover panel 300 and one side in the length direction rotatably connected to the first part 131. The second part 132 may rotate upwardly when/if the cover panel 300 is folded. When/if the cover panel 300 is folded, the cover panel 300 may be disposed below the second part 132.

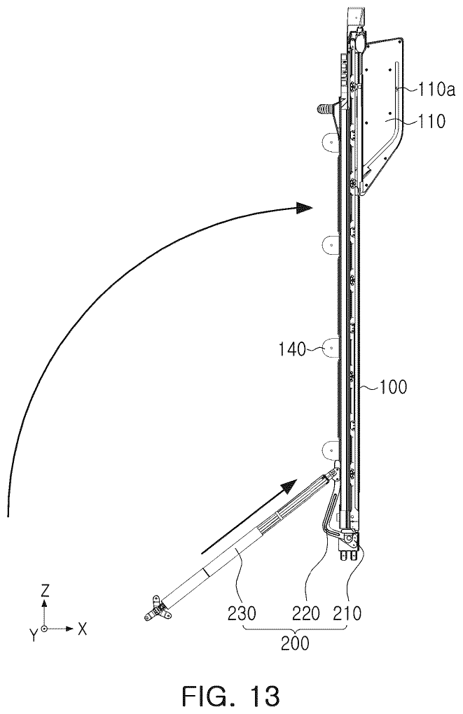

FIG. 12 is a side view of a driving unit of a cargo bed cover according to an example. FIG. 13 is a side view of a state in which a cargo bed cover is raised by a driving unit according to an example.

Referring to FIG. 12, the driving unit 200 may be provided to rotate the guide rail 100. A first side/end of the guide rail 100 in the length direction may be rotatably connected to the cargo bed S. The driving unit 200 may press the guide rail 100, and/or may rotate the guide rail 100 by raising or lowering the second side/end of the guide rail 100 in the length direction. As the driving unit 200 raises or lowers the second side of the guide rail 100 in the length direction, a distance between the second side of the guide rail 100 in the length direction and a corresponding second side of the cargo bed S in the length direction may increase or decrease, respectively.

The driving unit 200 may include, for example, a hinge fixing part 210 (e.g., a hinge/hinge connector), a rod part 220 (a rod), and a driving part 230 (e.g., a main actuator, a main motor, etc.). The hinge fixing part 210 (e.g., hinge) may be fixed to the cargo bed S. A first end of the rod part 220 may be rotatably coupled to the hinge fixing part 210, and a second end of the rod part 220, opposite to the first end of the rod part 220, may be coupled to the guide rail 100. A first end of the driving part 230 may be connected to the cargo bed S, and a second end of the driving part 230, opposite to the first end of the driving part 230, may be connected to the second side/end of the rod part 220. The driving part 230 may extend or contract, thereby rotating the rod part 220. When/if the rod part 220 rotates, the guide rail 100 may rotate. The driving part 230 may be provided, for example, as a spindle or a gas lifter. However, as long as the rod part 220 is pressed to rotate the guide rail 100, the driving part 230 may comprise and/or be changed to/implemented as one or more of various actuators.

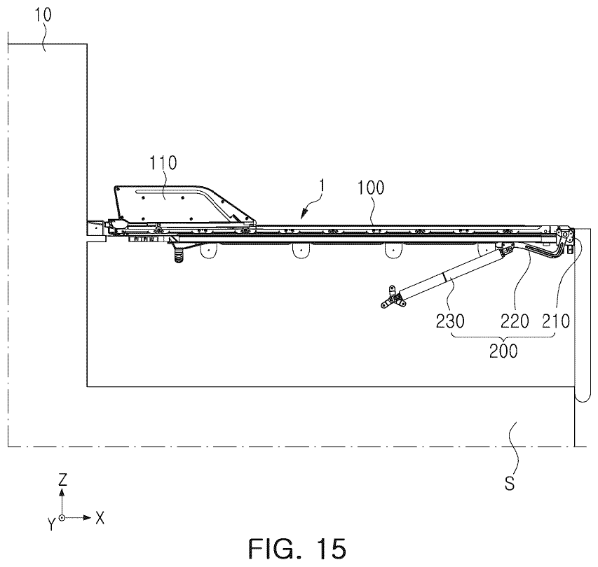

FIG. 14 is a perspective view of a state in which a cargo bed cover is provided in a first mode on a vehicle according to an example. FIG. 15 is a cross-sectional view of a state in which a cargo bed cover is provided in a first mode on a vehicle according to an example.

Referring to FIGS. 14 and 15, the cargo bed cover 1 according to an example may be connected to the cargo bed S of the vehicle 10. In the first mode, the cargo bed cover 1 may be provided to cover an upper portion of the cargo bed S. In the first mode, when/if the cover panel 300 of the cargo bed cover 1 slidably moves along the guide rail 100, the upper portion of the cargo bed S may be opened or closed.

FIG. 16 is a perspective view of a state in which a cargo bed cover is provided in a second mode on a vehicle according to an example. FIG. 17 is a cross-sectional view of a state in which a cargo bed cover is provided in a second mode on a vehicle according to an example.

Referring to FIGS. 16 and 17, the second mode may refer to a state in which the cargo bed cover 1 is rotated by a predetermined angle, as compared to the first mode. For example, the second mode may refer to a state in which the other side of the cargo bed cover 1 in the length direction is raised by a predetermined angle from the first mode. For example, in the second mode, the cargo bed cover 1 may be upwardly rotated by 20 degrees, as compared to the first mode. The cargo bed cover 1 may include a stay rod 500. The stay rod 500 may fix a position of the guide rail 100. For example, one side of the stay rod 500 may be connected to the other side of the cargo bed S in the length direction, and the other side of the stay rod 500 may be connected to the other side of the guide rail 100 in the length direction, thereby fixing the guide rail 100. The stay rod 500 may support the guide rail 100 to fix the position of the guide rail 100. The stay rod 500 may have a variable length. For example, the stay rod 500 may have a telescopic structure configured to allow the variable length of the stay rod 500.

In the second mode, the tent cover 430 provided on the tent frame 400 may be drawn out to the outside of the tent frame. For example, the side tent covers 431 of the pair of side frames 410 may be drawn out to the outside and connected to both sides of the cargo bed S in the width direction, and the front tent cover 432 of the connecting frame 420 may be drawn out to the outside and connected to the other side of the cargo bed S in the length direction. Adjacent portions of the side tent cover 431 and the front tent cover 432 may be connected to each other (e.g., by a Velcro, hooks, snaps, or a zipper). In the second mode, the cargo bed cover 1 according to an example may reduce drag generated by a vortex behind a vehicle 10 when/if the vehicle 10 is driven, thereby improving fuel efficiency of the vehicle.

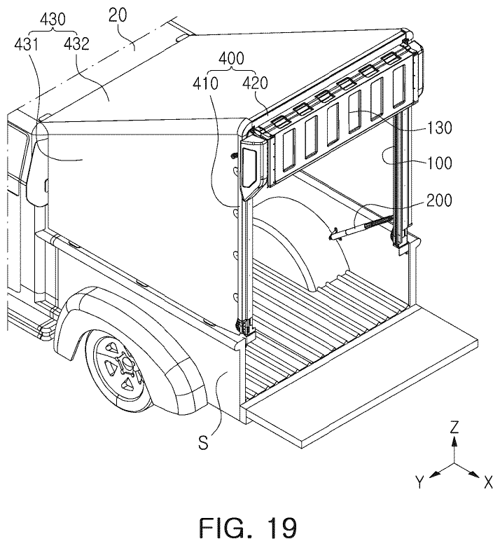

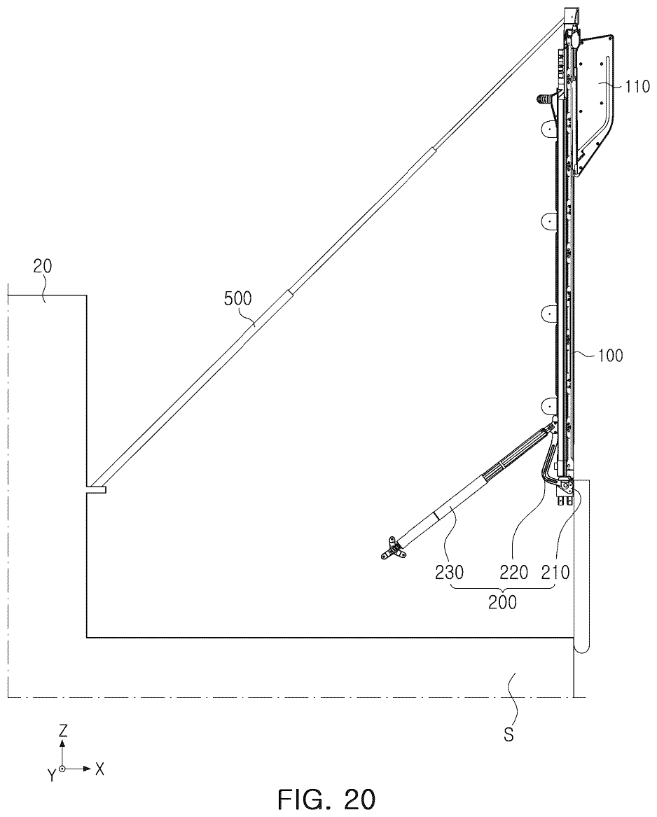

FIG. 18 is a perspective view of a state in which a cargo bed cover is provided in a third mode on a vehicle according to an example. FIG. 19 is a perspective view of a state in which a cover panel is open in FIG. 18. FIG. 20 is a cross-sectional view of a state in which a cargo bed cover 1 is provided in a third mode on a vehicle according to an example. The third mode may refer to a state in which the cargo bed cover 1 may be upwardly rotated by a predetermined angle, as compared to the first mode. For example, the third mode may refer to a state in which the cargo bed cover 1 is upwardly rotated by 90 degrees, as compared to the first mode. A mode of the cargo bed cover 1 may be switched to the third mode in a state in which the vehicle 10 is stopped, for example. In the third mode, the tent cover 430 provided on the tent frame 400 may be drawn out to the outside of the tent frame 400. For example, the side tent covers 431 of the pair of side frames 410 may be drawn out to the outside and connected to both sides of the cargo bed S in the width direction, and the front tent cover 432 of the connecting frame 420 may be drawn out to the outside and connected to the other side of the cargo bed S in the length direction. Adjacent portions of the side tent cover 431 and the front tent cover 432 may be connected to each other (e.g., by a Velcro, hooks, snaps, or a zipper). A mode of the cargo bed cover 1 according to an example may be switched to the third mode to provide a resting space for a user. In other words, when the mode of the cargo bed cover 1 is switched to the third mode, the vehicle 10 and the cargo bed cover 1 may perform a tent function.

The present disclosure provides a cargo bed cover that is convertible into various structures, and a vehicle including the cargo bed.

The present disclosure provides a cargo bed cover including a guide rail rotatably provided on each of both sides of a cargo bed of a vehicle in a width direction, a driving unit configured to rotate the guide rail, a cover panel slidably moving along the guide rail, the cover panel provided to be foldable, and a tent frame detachably coupled to the guide rail, the tent frame having a tent cover on the inside thereof.

A cargo bed cover may comprise: a guide rail rotatably provided on each of both sides of a cargo bed of a vehicle in a width direction; a driving unit configured to rotate the guide rail; a cover panel slidably moving along the guide rail, the cover panel provided to be foldable; and a tent frame detachably coupled to the guide rail, the tent frame having a tent cover on the inside thereof. The guide rail may have one side, in a length direction, rotatably hinged to one side of the cargo bed in the length direction. The driving unit may raise or lower the other side of the guide rail in the length direction, and a distance between the other side of the guide rail in the length direction and the other side of the cargo bed in the length increases or decreases as the driving unit raises or lowers the guide rail. The driving unit may include: a hinge fixing part coupled to the cargo bed; a rod part having one end rotatably coupled to the hinge fixing part and the other end coupled to the guide rail; and a driving part having one end connected to the cargo bed and the other end connected to the other side of the rod part, the driving part configured to rotate the rod part. The tent frame may include: a pair of side frames coupled to the guide rail, the pair of side frames respectively having a side tent cover provided on the inside thereof, the pair of side frames spaced apart from each other in the width direction; and a connecting frame connecting the pair of side frames to each other, the connecting frame having a front tent cover provided on the inside thereof. The side tent cover and the front tent cover may be elastically rolled and coupled to the side frame and the connecting frame, respectively, such that the side tent cover and the front tent cover are drawn out to the outside when an external force is applied, and the side tent cover and the front tent cover return to original positions thereof when the external force is released. The side frame may include: a side part having the side tent cover therein, the side part disposed on the outside of the guide rail in the width direction; and a flange part extending from the side part, the flange part coupled to the guide rail. A guide panel, configured to guide movement of the cover panel, may be provided on the other side of the guide panel in the length direction. The inside of the guide rail may have a first guide groove in which both ends of the cover panel in the width direction are mounted and move. The guide panel may have a second guide groove selectively connected to the first guide groove, the second guide groove including an upwardly inclined section toward the other side of the guide rail in the length direction. The guide rail may have a cap member configured to connect or separate the first guide groove and the second guide groove to each other or from each other as the cap member rotates. The cargo bed cover may further comprise: a cover rotatably provided on the guide rail, the cover below which the cover panel is disposed when the cover panel is folded. The cover may include: a first part having one end rotatably provided on the other side of the guide rail in the length direction; and a second part having both sides in the width direction rotatably connected to the cover panel and one side in the length direction rotatably connected to the first part, the second part rotating upwardly when the cover panel is folded, such that the cover panel is disposed therebelow. The cargo bed cover may further comprise: a stay rod having one side detachably connected to the other side of the cargo bed in the length direction, and the other side detachably connected to the other side of the guide rail in the length direction, the stay rod configured to support the guide rail when the driving unit rotates the guide rail by a predetermined angle. The stay rod may have a telescopic structure, and thus has a variable length. A vehicle may comprise the cargo bed cover.

In an example, a cargo bed cover may be converted into various structures, as necessary and/or desired, thereby expanding a cargo space or improving fuel efficiency of a vehicle.

While examples have been shown and described above, it will be apparent to those skilled in the art that modifications and variations could be made without departing from the scope of the present disclosure as defined by the appended claims.

What is claimed is:

1. A cargo bed cover comprising:
guide rails rotatably provided on opposite sides, in a first direction, of a cargo bed of a vehicle;
one or more actuators configured to rotate the guide rails;
a cover panel configured to slidably move along the guide rails, wherein the cover panel is foldable; and
a tent frame, detachably coupled to the guide rails, configured to reversibly enclose a tent cover.

2. The cargo bed cover of claim 1, wherein first sides of the guide rails comprise first ends, in a second direction perpendicular to the first direction, rotatably hinged to a first side, in the second direction, of the cargo bed.

3. The cargo bed cover of claim 2, wherein the one or more actuators are configured to raise or lower second ends of the guide rails, opposite to the first ends in the second direction, such that a distance between the second ends of the guide rails the cargo bed increases or decreases.

4. The cargo bed cover of claim 2, wherein guide panels, configured to guide movement of the cover panel, are provided on second sides, in the second direction, of the guide rails.

5. The cargo bed cover of claim 4, wherein
inside surfaces of the guide rails form first guide grooves in which ends of the cover panel are mounted and configured to move, and
the guide panels form second guide grooves selectively connectable to the first guide grooves, the second guide grooves each comprising an inclined section inclined upwardly toward the second side of the guide rails.

6. The cargo bed cover of claim 5, wherein the guide rails comprise caps configured to rotate to connect or separate the first guide grooves to or from the second guide grooves.

7. The cargo bed cover of claim 2, further comprising:
a stay rod comprising a first end detachably connectable to a second side, in the second direction, of the cargo bed, and a second end detachably connected to a second side, in the second direction, of one of the guide rails, wherein the stay rod is configured to support the guide rail rotated by the one or more actuators to a predetermined angle.

8. The cargo bed cover of claim 7, wherein the stay rod comprises a telescopic structure configured to allow the stay rod to have a variable length.

9. The cargo bed cover of claim 1, wherein the one or more actuators each comprise:
a hinge coupled to the cargo bed;
a rod comprising a first end rotatably coupled to the hinge and a second end, opposite to the first end, coupled to one of the guide rails; and
a driving actuator comprising a first end connected to the cargo bed and a second end, opposite to the first end, connected to the second end of the rod, the driving actuator configured to rotate the rod.

10. The cargo bed cover of claim 1, wherein the tent frame comprises:
side frames coupled to the guide rails, the side frames each configured to reversibly encompass a corresponding one of side tent covers, the side frames spaced apart from each other in the first direction; and
a connecting frame connecting the side frames to each other and configured to reversibly encompass a front tent cover.

11. The cargo bed cover of claim 10, wherein:
the side tent covers are elastically rolled and coupled to the side frames such that the side tent covers are configured to:
be drawn, based on a first applied external force, outside of the side frames; and
return, based on removal of the first applied external force, to be encompassed by the side frames; and
the front tent cover is elastically rolled and coupled to the connecting frame, such that the front tent cover is configured to:
be drawn, based on a second applied external force, outside of the connecting frame; and
return, based on removal of the second applied external force, to be encompassed by the connecting frame.

12. The cargo bed cover of claim 10, wherein each side frame of the side frames comprises:
a side chamber configured to encompass the corresponding one of the side tent covers, wherein the side chamber is disposed on an outside, in the first direction, of a corresponding guide rail of the guide rails; and
a flange, extending from the side chamber, coupled to the corresponding guide rail.

13. The cargo bed cover of claim 1, further comprising:
a cover, rotatably provided on the guide rails, configured to cover the cover panel based on the cover panel being folded.

14. The cargo bed cover of claim 13, wherein first ends, in a second direction perpendicular to the first direction, of the guide rails are rotatably attached to the cargo bed, and the cover comprises:
a first cover portion comprising a first end rotatably provided on second ends, in the second direction, of the guide rails; and
a second cover portion comprising:
opposite sides, in the first direction, rotatably connected to the cover panels, and
a first side, in the second direction, rotatably connected to the first cover portion, wherein the second cover portion is configured to rotate upwardly based on the cover panel being folded, such that the folded cover panel is disposed below the second cover portion.

15. A cargo bed cover comprising:
guide rails provided on opposite sides, in a first direction, of a cargo bed of a vehicle, wherein first sides of the guide rails comprise first ends, in a second direction perpendicular to the first direction, rotatably hinged to a first side, in the second direction, of the cargo bed;
one or more actuators configured to rotate the guide rails about the first ends of the guide rails; and
a cover panel configured to move along the guide rails.

16. The cargo bed cover of claim 15, wherein cover panel is configured to fold or unfold as it moves along the guide rails.

17. The cargo bed cover of claim 15, further comprising: a tent frame, detachably coupled to the guide rails, configured to reversibly enclose a tent cover.

18. The cargo bed cover of claim 15, wherein the one or more actuators are configured to raise or lower second ends, opposite to the first ends, of the guide rails.

19. The cargo bed cover of claim 15, wherein guide panels, configured to guide movement of the cover panel, are provided on a second side, in the second direction, of the guide rails.

20. A vehicle comprising:
a cargo bed; and
a cargo bed cover comprising:
guide rails rotatably provided on opposite sides, in a first direction, of a cargo bed of the vehicle;
one or more actuators configured to rotate the guide rails;
a cover panel configured to slidably move along the guide rails, wherein the cover panel is foldable; and
a tent frame, detachably coupled to the guide rails, configured to reversibly enclose a tent cover.
